(19) United States
(12) Patent Application Publication
(10) Pub. No.: US 2010/0132354 A1
(43) Pub. Date: Jun. 3, 2010

(54) LINEAR-ROTARY MOTION CONVERSION MECHANISM

(76) Inventors: David Ian Fanner, Christchurch (NZ); Donald Murray Clucas, Christchurch (NZ); Mark Harinui Thomson, Christchurch (NZ); Andrew Karl Diehl, Christchurch (NZ)

Correspondence Address: FROMMER LAWRENCE & HAUG, 745 FIFTH AVENUE- 10TH FL., NEW YORK, NY, 10151, US

(21) Appl. No.: 12/518,723

(22) PCT Filed: Dec. 12, 2007
(86) PCT No.: PCT/NZ2007/000359

§ 371 Date: Oct. 22, 2009

(30) Foreign Application Priority Data
Dec. 12, 2006 (NZ) 552006

(51) Int. Cl. F01B 3/02; F16H 23/00; F02G 1/00

(52) U.S. Cl. 60/525; 74/60

(57) ABSTRACT

An axial mechanism for converting between linear reciprocating motion and rotary motion comprises a z-crank shaft, a wobble member rotationally mounted to the angled crank pin of the z-crank shaft, and one or more pistons with a connecting rod between each piston and a pivot joint to the wobble member. In one embodiment the connecting rods have sufficient inherent flexibility to accommodate sideways motion in a 360° orbit at the wobble member end of the connecting rod. In another embodiment there is a lubrication communication passage from within the wobble member to each of said pivot joints. In another embodiment each such pivot joint is fitted to the wobble member an integral unit. In another embodiment the z-crank shaft is supported for rotation by bearings all positioned to one side of the z-crank shaft, spaced along the output drive end of the z-crank shaft. In another embodiment a torque restraint member is coupled between the wobble member and a non-moving reference point via a resilient mount or bearing which allows for limited oscillatory and longitudinal movement of the torque restraint member.

### FIELD OF INVENTION

The invention comprises a mechanism for converting linear reciprocating motion, from one or more pistons for example, to rotary motion about an axis parallel to the axes of linear motion of the pistons. Alternatively the mechanism may convert rotary motion to linear reciprocating motion. The mechanism may be used in an engine, pump, refrigerator, or compressor for example.

### BACKGROUND OF INVENTION

In an axial engine linear reciprocating motion from pistons is converted to rotary motion about an axis parallel to the axes of the linear reciprocating piston motion. Typically multiple pistons are arranged around the axis of the output shaft of the engine. Alternatively in a pump or compressor of a similar configuration, input rotary motion is converted to linear reciprocating motion of a number of pistons, along a parallel axis or axes parallel to that of the rotary input motion.

Swash plate mechanisms are known for converting between linear reciprocating motion and rotary motion. Swash plate mechanisms are extensively used in for example automotive air conditioning pumps, and are used in several forms of Stirling engine (heat engine).

Wobble or z-crank mechanisms are also known for converting between linear reciprocating motion and rotary motion and can offer better mechanical efficiency in low power applications.

### SUMMARY OF INVENTION

It is an object of the invention to provide an improved or at least alternative form of axial mechanism for converting between linear reciprocating motion and rotary motion.

In broad terms in one aspect the invention comprises an axial mechanism for converting between linear reciprocating motion and rotary motion about a substantially parallel axis, comprising
a z-crank shaft mounted for rotation about a longitudinal axis of the z-crank shaft, the z-crank shaft inducing an output drive end and an angled crank pin,
a wobble member rotationally mounted to the angled crank pin of the z-crank shaft, and
one or more pistons with a connecting rod between each piston and a joint to the wobble member, for coupling linear reciprocating motion between the piston and the wobble member, the connecting rod having sufficient inherent flexibility to accommodate sideways motion in a 360° orbit at or towards the wobble member end of the connecting rod.

Preferably each Connecting rod is substantially rigidly coupled to its piston at the upper end of the connecting rod.

Preferably each connecting rod is formed with a circular cross-section and with a diameter relative to length such as to give the connecting rod the required degree of flexibility. The connecting rod may have a diameter which is more than ten times less than its length.

In broad terms in another aspect the invention comprises an axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft, and
one or more pistons each connected through a joint to the wobble member for coupling linear reciprocating motion to the wobble member, and
   a lubrication communication passage from within the wobble member to each said joint by which a piston is connected to the wobble member.

Typically each said joint comprises a number of bearings to which lubricant is provided from within the wobble member.

Preferably the wobble member has a hollow interior which may contain lubricant.

In one form the z-crank shaft comprises an internal lubrication communication passage to the hollow interior of the wobble member by which in operation of the mechanism lubricant under pressure is provided to the wobble member and/or to bearings mounting the wobble member to the crank pin of the z-crank shaft and/or to each said joint by which a piston is connected to the wobble member.

In broad terms in another aspect the invention comprises an axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft, and
one or more pistons each connected through a joint to the wobble member, which joint comprises a number of bearings and is fitted to the wobble member as an integral unit.

Preferably each said integral joint unit comprising a number of bearings is threadedly mounted to the wobble member.

In broad terms in another aspect the invention comprises an axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin, the z-crank shaft being supported for rotation by bearings all positioned to one side of the z-crank shaft, spaced along the output drive end of the z-crank shaft, and
a wobble member rotationally mounted to the angled crank pin of the z-crank shaft, one or more linkages for coupling linear reciprocating motion to the wobble member.

With this arrangement there is no bearing on the other side of the crank pin. Preferably also balance weights are provided on the same output drive end of the z-crank.

In broad terms in another aspect the invention comprises an axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft,
   one or more linkages for coupling linear reciprocating motion to the swash member, and
a torque restraint member coupled between the swash member and a non-moving reference point via a resilient mount or bearing which allows for limited oscillatory movement of the torque restraint arm and which preferably also allows for limited movement in the direction of a longitudinal axis of the torque restraint arm.

Preferably the resilient mount or bearing is arranged to apply some degree of tension on the end of the torque restraint arm towards the hub centre.

Preferably the torque restraint member is pivotally coupled to the wobble member on either side of the rotational axis of the z-crank shaft, along an axis passing transversely through a longitudinal axis of the crank pin at a point at which a longitudinal axis of the output drive end passes through the longitudinal axis of the crank pin of the z-crank shaft in particular on either side of a point referred to herein as the “hub centre”.

In this specification, “converting reciprocating motion to rotary motion” includes the opposite conversion—of rotary motion to reciprocating motion, unless the text indicates otherwise. Also, the term “piston” includes, but is not to be limited to: a piston of known type in a single- or double-acting engine; a displaces; and a reciprocating ram such as can be used as a positioning mechanism.

The term ‘comprising’ as used in this specification and claims means ‘consisting at least in part of’, that is to say when interrupting independent claims including that term, the features prefaced by that term in each claim will need to be present but other features can also be present.

### BRIEF DESCRIPTION OF THE DRAWINGS

The accompanying drawings show a preferred form of the mechanism of the invention utilised in an external combustion/heat engine, by way of example and without intending to be limiting. In the drawings:

FIG. 1 is a perspective view of z-crank shaft, wobble member, cylinders with pistons within and connecting rods, and torque restraint member of an engine comprising the preferred form mechanism, the engine being a Stirling engine,

FIG. 2 is a perspective view of the z-crank shaft, wobble member, and torque restraint member of the preferred form mechanism, removed from the engine and separate from the cylinders, pistons and connecting rods, showing however four universal joints carried by the wobble member for coupling to the connecting rods,

FIG. 3 is a side view of the mechanism removed from the engine showing the same parts as in FIG. 2, and also the connecting rods, from one side,

FIG. 4 is a view of the mechanism from above (as later defined),

FIG. 5 is a cross-section view of the mechanism of FIGS. 3 and 4 along line A-A of FIG. 4,

FIG. 6 is a cross-section view of the mechanism of FIGS. 3 to 5 along line C-C of FIG. 3,

FIG. 7 is a cross-section view similar to FIG. 5 but of the mechanism in place within the casing of an engine-generator also showing the generator in cross-section and the bottom balance weights of the mechanism,

FIG. 8 is an enlarged perspective view of the torque restraint member of the preferred form mechanism of FIGS. 3 to 6, separate from the rest of the mechanism,

FIG. 9 is an exploded view of the torque restraint member and the wobble member and bearings,

FIG. 10 is a perspective view of the preferred form mechanism from above, partly exploded,

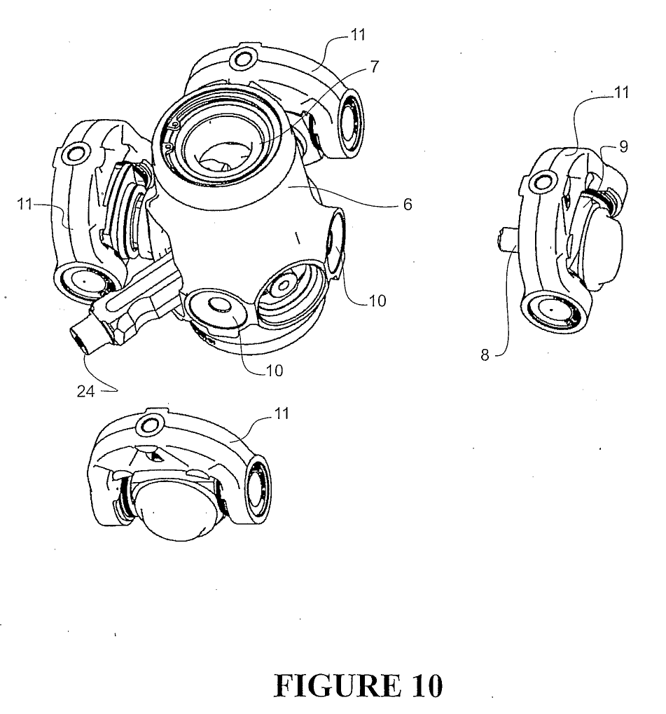

FIG. 11 is a partly exploded view of the preferred form mechanism from one side,

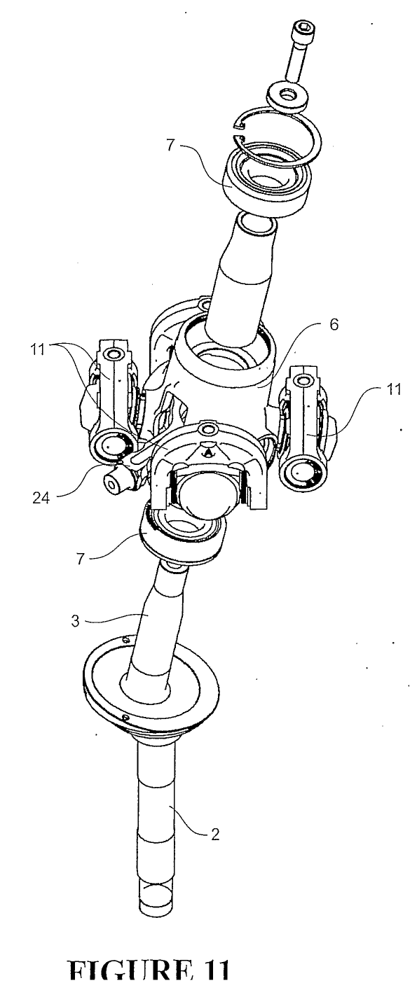

FIG. 12a is a close up view and FIG. 12b a cross-section view through one arrangement for mounting a bearing at the outer end of one form of torque restraint member.

### DETAILED DESCRIPTION OF PREFERRED FORMS

The preferred form linear-rotary motion conversion mechanism of the invention is described as part of an engine and in particular a Stirling engine, for converting linear reciprocating piston motion to rotary motion of an output shaft of the engine. In this description the terms “upper” or “top” and “lower” or “bottom” or similar are used to describe the mechanism in an orientation in which the output drive end of the z-crank shaft is lowermost and the crank pin of the z-crank shaft is uppermost, but it will be appreciated that the mechanism may be used in an engine (or pump or compressor) in which the output end of the crank shaft is uppermost, or to either side, or in any orientation, and the use of the relative terms upper or top and lower or bottom or similar should not be read as limiting the following description.

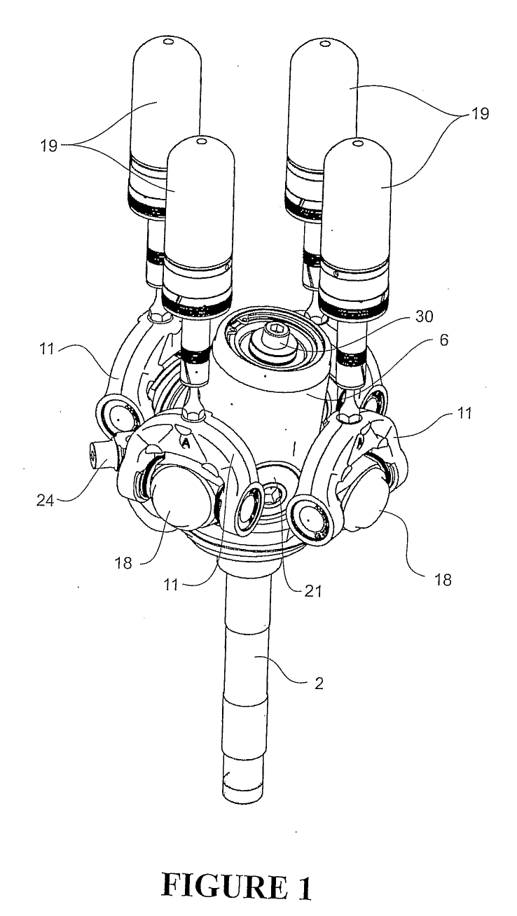

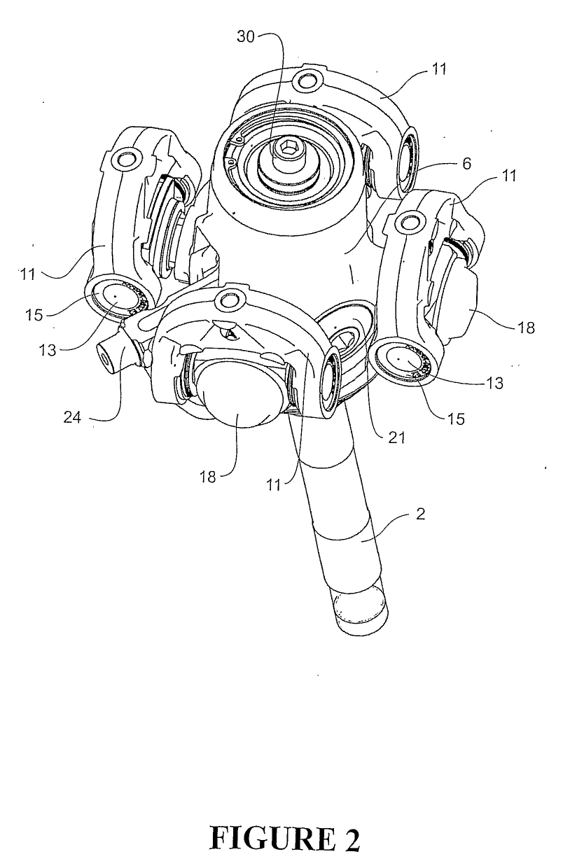

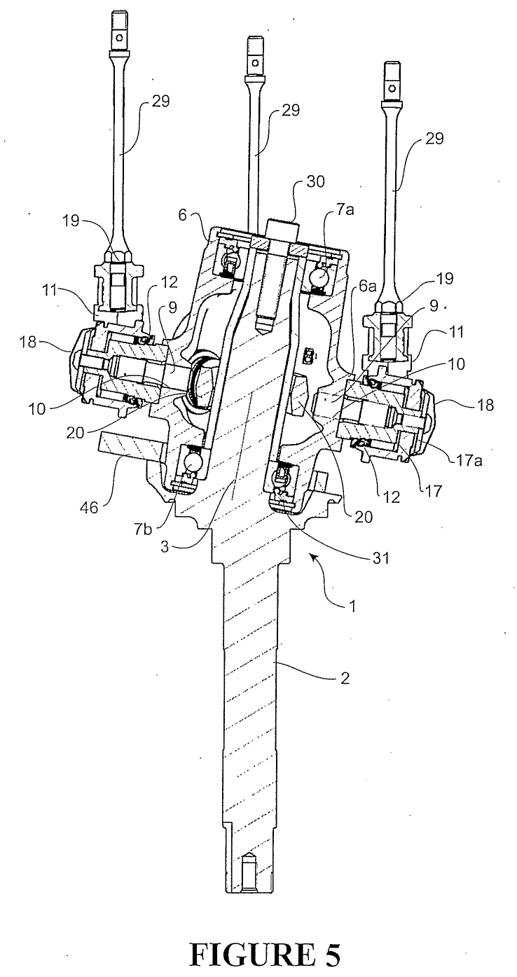

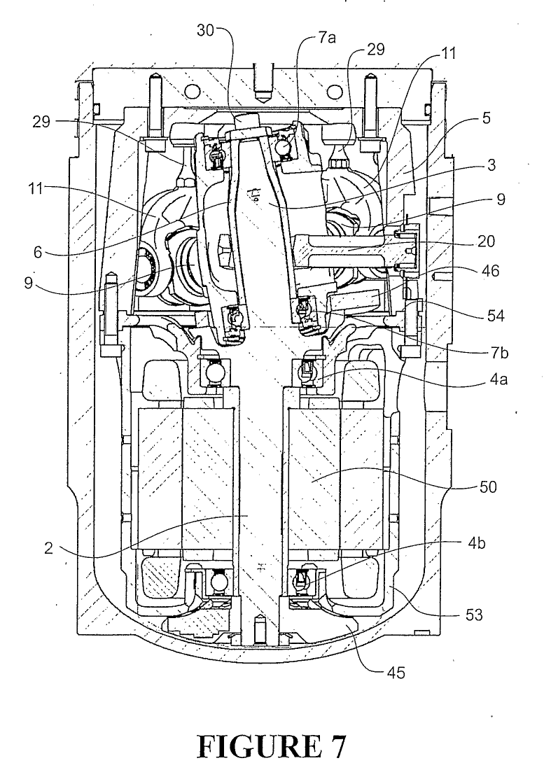

Referring initially to FIGS. 1 to 7, the z-crank shaft of the preferred form mechanism is indicated at 1. It comprises an output drive end 2 and an angled crank pin 3 (see particularly FIG. 5). The z-crank shaft 1 is mounted for rotation about the longitudinal axis of the output drive end 2. In the preferred form shown the z-crank shaft 1 is mounted in an upper bearing 4a provided in an engine casing 5 of the engine (see FIG. 7), and in a lower bearing 4b. In the embodiment shown the Stirling engine drives an electrical generator or alternator (herein referred to as a generator for convenience). The rotor assembly 50 of the generator is carried on the output drive end 2 of the z-crank shaft. The rotor assembly can comprise laminations and windings as shown or be of a permanent magnet type interacting with a wound stator. The lower bearing 4b is mounted in a lower part of the generator casing 53, around the bottom end of the output drive end 2 of the z-crank shaft. The upper bearing 4a is also around the output drive end 2 of the z-crank shaft, below the crank pin 3.

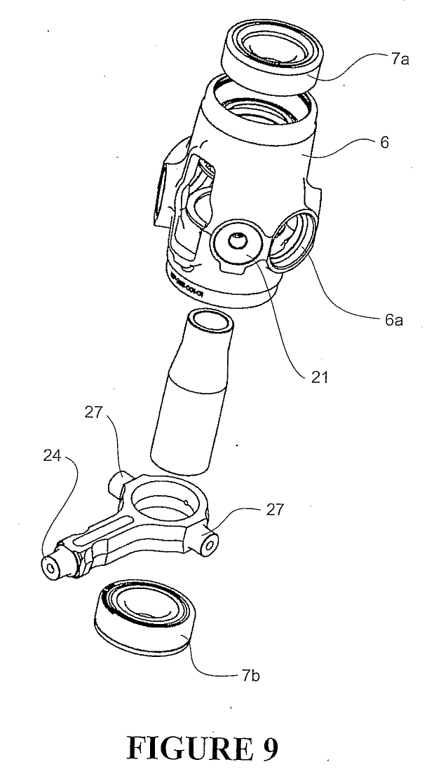

A wobble member 6 is rotationally mounted on the angled crank pin 3. In the preferred form the wobble member 6 is of a generally tubular or cylindrical form as shown and is carried on the z-crank shaft 1 by upper and lower bearings 7a and 7b which may for example be ball bearings (see FIGS. 5, 7 and 9), provided at or near either end of the wobble member 6, and in particular on either side of a boss portion 6a of the wobble member, at which four knuckle joints for coupling to the lower ends of connecting rods 29 from four pistons operating in cylinders 19 (see FIG. 1) are mounted to the wobble member 6. At the same boss portion 6a the torque restraint member is coupled to the wobble member 6 as will be further described. Bolt 30 passes through the top of the wobble member 6 and threads into an axial bore in the top of the crank pin 3 (see FIG. 5).

For convenience in this description the wobble member 6 will hereafter be referred to as the boss 6.

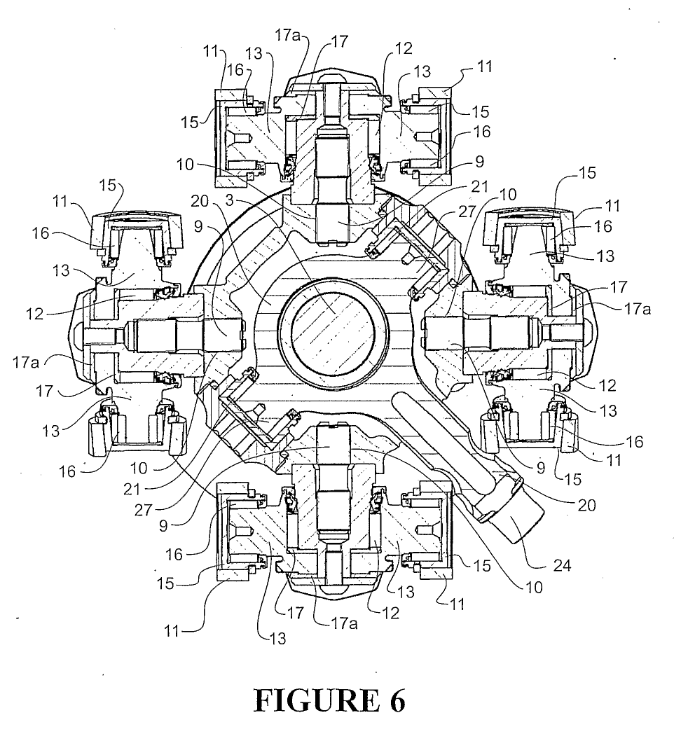

As referred to four knuckle joints for coupling to the connecting rods of pistons. of the engine are equidistantly spaced around the boss 6 as shown, and are fixed to the boss 6. In the preferred form a reduced diameter end 8 of each of four hub pins 9 are threaded into transverse bores 10 radially spaced around the boss 6 (see FIG. 6). In the preferred form shown the boss 6 and hub pins 9 are formed as separate components but alternatively the boss 6 and hub pins 9 or equivalent may be formed as a single integral component, in any form. A clevis 11 is pivotally mounted to the outer end of each hub pin 9 about a transverse axis via a hub pin bearing 12. A con rod pin 13. The con rod pin 13 has an enlarged yoke 14 with a bore transverse to the longitudinal axis of the con rod pin 13, whereby the con rod pin fits over the outer end of the hub pin 9, and is mounted to the hub pin 9 via a hub pin bearing 12, in the preferred form shown as a needle roller bearing. The arms of the clevis 11 are coupled to the ends of the con rod pin 13 via con rod cups 15 which fit through apertures in the arms of the clevis and over connecting rod bearings 16, preferably needle roller bearings, provided on the ends of the hub pin 9. Inner and outer thrust bearing 17 and 17a are also provided between the con rod pin 13 and the hub pin 9 at the outer end of the hub pin. The bearings are covered by a cap 18 with a seal at the mouth of the cap 18 around the exterior of the hub pin 9. The lower end of a connecting rod 29 couples to each clevis 11, in the preferred form by a threaded connection into the upper bridge part of each clevis (see in particular FIG. 5). In a variation to the embodiment described each of the bearings 12, 16, and 17 could be replaced by bushes.

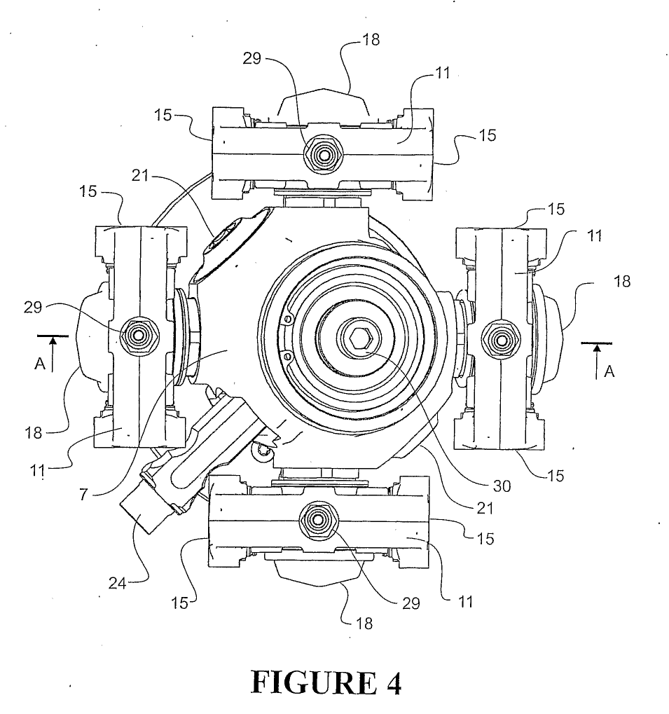

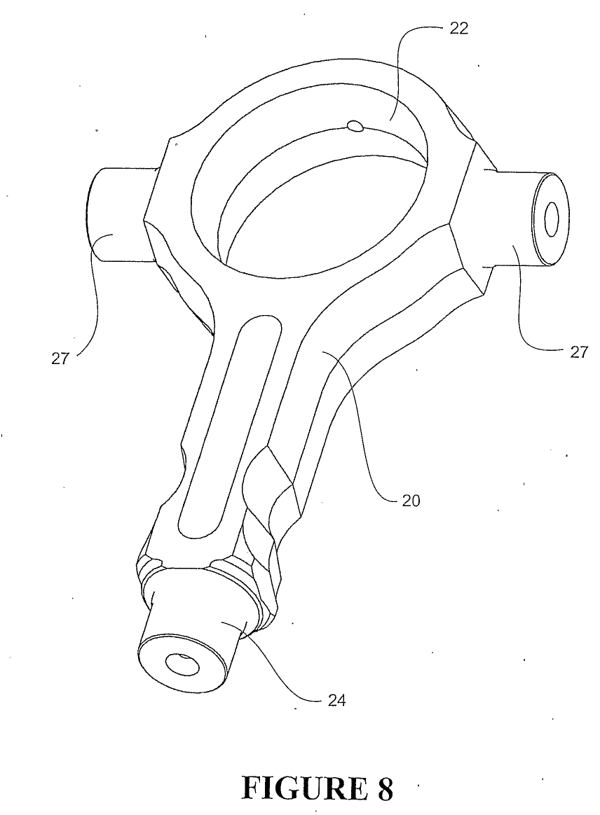

Referring particularly to FIGS. 4, 6, 8, and 9, the torque restraint member of the preferred form mechanism is indicated at 20. At one end the torque restraint member is coupled to the boss 6 and in the particular embodiment shown the torque restraint member also encircles the z-crank shaft. The crank pin 3 passes through and is free to move within the aperture 22 in the torque restraint member 20 (without contacting the torque restraint member). Stub shafts 27 project from the torque restraint member into bearings 21 such as needle roller bearings, on either side of the boss 6, from within the interior of the boss 6, such that a longitudinal axis through the stub shafts 27 passes transversely through the longitudinal axis of the angled crank pin 3, at the point at which the longitudinal axis of the output drive end 2 of the z-crank shaft 1 intersects the longitudinal axis of the crank pin For convenience this point is referred to herein as the “hub centre” (or alternatively as the notating centre or wobble centre). This enables the torque restraint member 20 to pivot about an axis passing through the hub centre, during movement of the mechanism. The bearings 21 are mounted in apertures in the side of the boss 6 one either side. In an alternative form two torque restraint arms may be coupled to the boss 6 at the same pivot points (along the same axis transversely through the boss centre), from either side of the engine (the ends 24 of each torque restraint arm are on either side of the mechanism/engine).

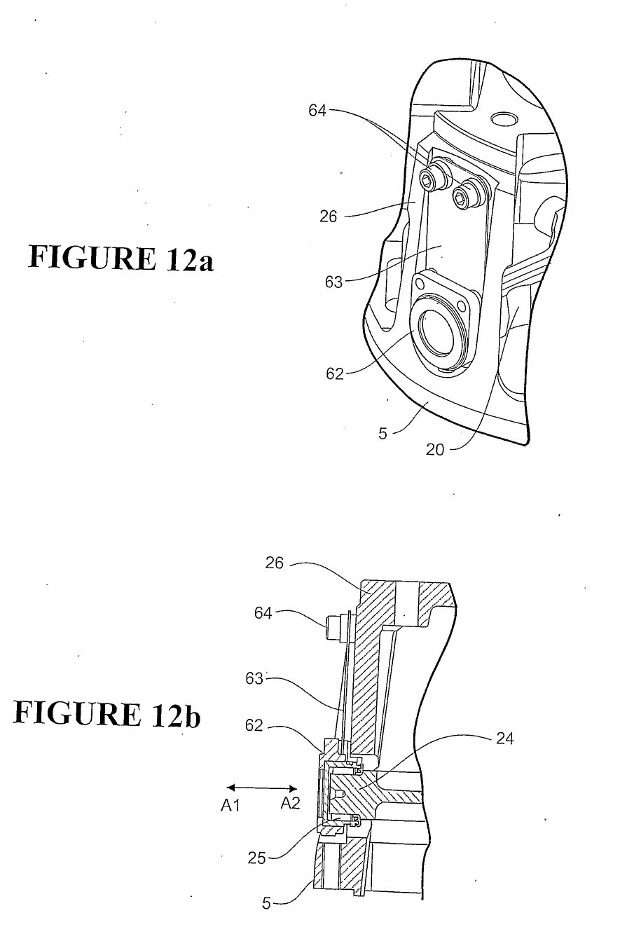

The other end 24 of the torque restraint member 20 is coupled directly or indirectly to the casing of the engine, as a non-moving reference point. In the preferred form the end 24 of the torque restraint arm 20 is mounted in a bearing 25 (referred to herein as anti-rotation bearing 25) in turn mounted in the part 5 of the engine casing. The end 24 of the torque restraint arm 20 may be fixed to the engine body or casing in any way, or to any other non-moving reference point, but must be fixed by a bearing which allows for reciprocating oscillatory movement of the torque restraint arm about the longitudinal axis of the end 24 thereof, if the longitudinal axis of the end 24 of the torque restraint arm 20 passes exactly through the hub centre of the mechanism. If it does not, the torque restraint arm 20 may also undergo some longitudinal reciprocating movement (reciprocating movement along the axis of the end 24 of the torque restraint arm 20) as the mechanism rotates. To accommodate at least a small degree of such longitudinal, reciprocating movement the anti-rotation bearing 25 may be mounted so as to allow the bearing to move in the direction of the longitudinal axis of the torque restraint arm, to some degree. For example the anti-rotation bearing 25 may be resiliently mounted to allow for any such longitudinal reciprocating movement of the end 24 of the torque restraint arm. FIGS. 12a and 12b show one arrangement for so mounting the anti-rotation bearing 25, by way of example. Reference numeral 26 indicates an upstand from a part 5 of the engine casing. A through-aperture is formed in a lower part of the upstand 26, into which the end 24 of the torque restraint arm 20 extends, with the anti-rotation bearing 25 thereon, which is shown as a needle roller bearing. The anti-rotation bearing 25 is in turn retained within a bearing mounting cap 62 fixed to the free end of a resilient element 63 which may be formed of spring steel for example, and the other end of which is fixed to the upstand 26 by fasteners 64 as shown. The arrangement is such that the lower end of the spring steel element 63 is free to flex reciprocally in the direction of arrows A1-A2 in FIG. 12b, while applying some force on end 24 of the torque restraint arm 20 towards the hub centre i.e. in the direction of arrow A2 which may be advantageous. A further benefit of such a resilient mount is that it will tend to be self-aligning. Any other alternative arrangement that will mount the anti-rotation bearing 25 so as to also allow for some longitudinal movement and/or self alignment may be employed.

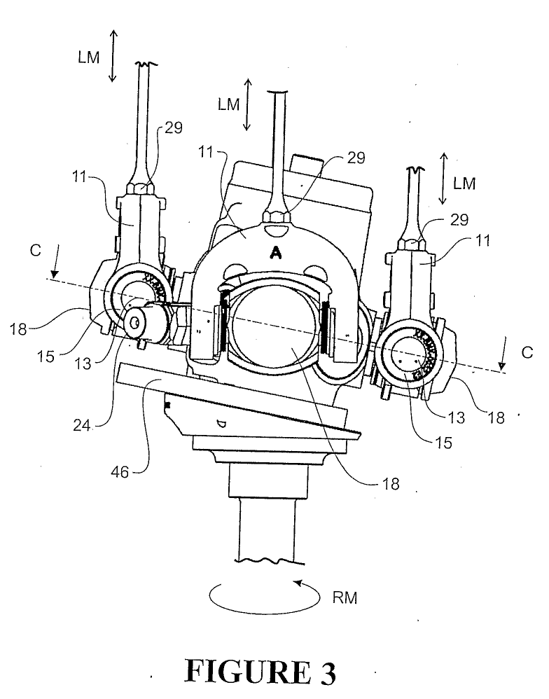

In operation, linear reciprocating motion of the connecting rods 29, driven by the pistons of the engine, in the direction of arrows LM in FIG. 3, is converted to rotary motion of the output shaft end 2 of the z-crank member 1, as indicated by arrow RM, (or vice versa is a pump or compressor application for example).

The torque restraint member pivotally coupled to the wobble member or boss 6, along a transverse axis passing through the hub centre results in the bearings 21 between the torque restraint arm and the wobble member or boss being comparatively lightly loaded, and relatively small bearings can be used. Preferably the axis passing through the bearings 21 between the torque restraint arm and the boss is at 45 degrees to the longitudinal axis of the cylinders of the engine and the connecting rods, which minimises the width of the figure of eight motion executed by the conrod connection knuckle joint during operation and consequently minimises side load on the pistons and vibration.

The figure of eight motion of the connecting rod ends causes a torsional vibration of the engine at twice engine frequency. Preferably for a four cylinder machine if the position of the bearing 25 is moved tangentially with suitable phasing to the shaft rotational position so that torsional vibration is cancelled.

During operation of the mechanism the lower ends of the connecting rods tend to undergo, as well as reciprocating motion in axis, some sideways motion in a 360° orbit, when viewed down the axis of the piston cylinder. In the preferred form this is accommodated by constructing the connecting rods to have sufficient inherent flexibility to accommodate this motion. Conventionally connecting rods are formed so as to be rigid. The connecting rods may have a circular or rounded cross-section. The cross-section diameter of the connecting rods relative to their length is such as to give the connecting rods the required degree of flexibility (although the connecting rods are formed from for example steel). The connecting rods will then flex through a 360 degree orbit at the knuckle joint end. The connecting rods may have a diameter which is more than ten times less than their length. The connecting rods still have sufficient rigidity to effectively transfer the downward piston force to the wobble mechanism without buckling of the connecting rod. The connecting rods may be described as double flexure connecting rods as they flex in two planes. The connection of the connecting rods to the pistons at the upper ends of the connecting rods may be rigid, thereby avoiding the need for a universal joint at this connection. There is then no need to provide lubrication at any such joint between the upper end of the connecting rod and piston.

In the preferred embodiment described the z-crank shaft 1 is supported by the bearing 4a mounted in the part 5 of the engine casing as referred to previously, and the bearing 4b mounted in the lower part of the generator casing 53, both below the angled crank pin 3 of the z-crank shaft 1. There is no bearing above the crank pin. In addition balance weights are provided below the. crank pin 3. An upper balance weight 46 is fixed towards the upper end of the z-crank shaft but below the crank pin 3, above the bearing 4a. A lower balance weight 45 is mounted below the bearing 4b. The lower balance weight 4b may also comprise vanes so that it will act as a cooling fan for the generator. With this arrangement it is also necessary only to provide a single seal, being the seal 31 (see FIG. 5) beneath the lower bearing 7 which mounts the boss 6 to the crank pin 3. This seal retains lubricant inside the hub assembly.

In the preferred form the hub pins 9 thread into the boss 6. Each hub pin 9 and connecting rod knuckle joint comprising the bearings 12, 16 and 17 can be formed as a separate unit from the boss 6 and subsequently threaded into the boss 6. This is advantageous for assembly of the mechanism, and also subsequent replacement of any of the knuckle joint bearings since it is necessary only to disconnect the connecting rod from the delis 11 which allows the knuckle joint-hub pin assembly to be unscrewed from the boss 6 and a replacement to be screwed into place.

In the preferred form mechanism shown the top of the hollow boss 6 is closed by a cap (not shown). The lower end of the boss 6 is sealed to the z-crank shaft by a rotary lip seal 31 (see FIG. 5) and each of the bearings 32 between the boss and the yoke ends 21a of the torque restraint arm have associated seals. Bores 10 communicate between the connecting rod knuckle joint bearings and the interior of the boss through the hub pins 9. In an oil lubricated system oil under pressure may be supplied under pressure via a bore up through the z-crank shaft 1 and via the bores 10 through the hub pins 9 to the hub pin bearings 12, connecting rod thrust bearings 17, and clevis—hub pin bearings 16. Oil can be transferred to the bores 10 by a shoe on the inner end of each hub pin 9, between the hub pin end and the crank pin of the z-crank shaft, which picks up the pressure oil supply. Alternatively in a non-pressure oil lubricated system the interior of the boss 6 may act as an oil reservoir, and a shoe between the end of each hub pin 9 and the crank pin may pick up oil as the mechanism operates and deliver it to the knuckle joint bearings. In a grease lubricated system the interior of the boss 6 may be packed with grease under pressure which feeds through the bores 10 to the knuckle joint bearings. During maintenance of the engine-mechanism, all bearings may be re-lubricated by supplying grease under pressure to a single nipple through a wall of the boss 6.

The forgoing describes the invention including preferred form thereof. Alterations and modifications as would be obvious to those skilled in the art are intended to be incorporated within the scope hereof as defined in the accompanying claims.

1. An axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft, and
one or more pistons with a connecting rod between each piston and a pivot joint to the wobble member, for coupling linear reciprocating motion between the piston and the wobble member, the connecting rod having sufficient inherent flexibility to accommodate sideways motion. in a 360° orbit at or towards the wobble member end of the connecting rod.

2. An axial mechanism according to claim 1 wherein the or each connecting rod is substantially rigidly coupled to its piston at one end of the connecting rod.

3. An axial mechanism according to claim 1 wherein the or each connecting rod comprises a substantially circular cross-section with a diameter relative to length such as to give the connecting rod said sufficient inherent flexibility to accommodate sideways motion in a 360° orbit at or towards the wobble member end of the connecting rod.

4. An axial mechanism according to claim 3 wherein each connecting rod has a diameter which is more than ten times less than its length.

5-9. (canceled)

10. An axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft, and
one or more pistons each connected to the wobble member through a pivot joint unit comprising a number of bearings and which is fitted to and removable from the wobble member as an integral unit comprising said bearings and without disassembly of said unit or said bearings.

11. An axial mechanism according to claim 10 wherein each said integral pivot joint unit is fitted to and removable from the wobble member through a threaded connection.

12. An axial mechanism according to claim 11 wherein each said integral pivot joint unit is threadedly mounted to the wobble member by a threaded hub pin part of the pivot joint unit which threads into the wobble member.

13-16. (canceled)

17. An axial mechanism for converting between linear reciprocating motion and rotary motion about a substantially parallel axis, comprising
a z-crank shaft mounted for rotation about a longitudinal axis of the z-crank shaft, the z-crank shaft including an output drive end and an angled crank pin,
a wobble member rotationally mounted to the angled crank pin of the z-crank shaft, one or more pistons with a connecting rod between each piston and a pivot joint to the wobble member for coupling linear reciprocating motion between the piston and the wobble member, and
a torque restraint member coupled between the wobble member and a non-moving reference point via a resilient mount or bearing which allows for limited oscillatory movement of the torque restraint member about a longitudinal axis of the torque restraint member to the angled crank pin, and limited movement along said axis.

18. An axial mechanism according to claim 17 wherein the resilient mount or bearing is arranged to apply force on the torque restraint member towards the angled crank pin.

19. An axial mechanism according to claim 17 wherein, one end of the torque restraint member is coupled to the angled crank pin of the z-crank shaft within an interior of the wobble member and the torque restraint member comprises stub shafts which project from said one end of the torque restraint member into bearings on either side of the wobble member.

20. An axial mechanism according to claim 17 wherein the torque restraint member is pivotally coupled to the wobble member along an axis passing transversely through the longitudinal axis of the angled crank pin of the z-crank shaft at the point at which the longitudinal axis of the output drive end of the z-crank shaft intersects the longitudinal axis of the angled crank pin.

21. An axial mechanism according to claim 17 wherein the torque restraint member is pivotally coupled to the wobble member along said axis passing transversely through the longitudinal axis of the angled crank pin of the z-crank shaft, at an angle of about 45 degrees to the longitudinal axis of the cylinders) and connecting rod(s) of the engine.

22-24. (canceled)

25. An engine having an axial mechanism according to claim 1 which is a heat engine.

26-31. (canceled)

32. An axial mechanism according to claim 10 also comprising a lubrication communication passage from within the wobble member to the bearings of the or each said pivot joint.

33. An axial mechanism according to claim 32 wherein the z-crank shaft comprises an internal lubrication communication passage to the hollow interior of the wobble member by which in operation of the mechanism lubricant under pressure is provided to the wobble member and/or to bearings mounting the wobble member to the crank pin of the z-crank shaft and/or to the lubrication communication passage(s) from within the wobble member to the or each pivot joint.

34. An axial mechanism according to claim 32 wherein a said lubrication communication passage communicates between each of said one or more pivot joints and the interior of the wobble member initially through a hub pin between the pivot joint and the wobble member.

35. An axial mechanism according to claim 10 wherein the wobble member has a hollow interior to contain a reservoir of lubricant.

36. An axial mechanism according to claim 17 wherein the resilient mount or bearing is carried at a free end of a resiliently flexible element which at its other end is fixed to said non-moving reference point.

37. An axial mechanism according to claim 36 wherein said resiliently flexible element is formed of spring metal.

38. An axial mechanism according to claim 36 wherein said resilient mount or bearing is sufficiently resiliently flexibly mounted so as to be self-aligning with said longitudinal axis of the torque restraint member.
